(19) United States
(12) Patent Application Publication
(10) Pub. No.: US 2025/0092339 A1
(43) Pub. Date: Mar. 20, 2025

(54) EXTRACTING ALPHA, BETA, AND ISO-ALPHA-ACIDS FROM HOPS

(71) Applicant: George STANTCHEV, Phoenix, AZ (US)

(72) Inventor: George STANTCHEV, Phoenix, AZ (US)

(21) Appl. No.: 18/885,749

(22) Filed: Sep. 16, 2024

Related U.S. Application Data
(60) Provisional application No. 63/538,844, filed on Sep. 17, 2023.

(51) Int. Cl. C12C 3/08

(52) U.S. Cl. CPC C12C 3/08

(57) ABSTRACT

An apparatus for extraction of hops with a liquified gas includes at least one extractor vessel with a heating jacket; at least one evaporator; a solvent recovery vessel with a heating jacket; at least one chiller; a thermal pump cooling the at least one chiller and heating the at least one evaporator; a receiving vessel with a cooling jacket; and a pump moving a pump moving solvent in the solvent recovery vessel; wherein the at least one extractor vessel, the at least one evaporator, the solvent recovery vessel, the one or more chillers, the thermal pump, the receiving vessel, and the pump work continuously under the same pressure conditions.

### CROSS REFERENCE TO RELATED PRESENT DISCLOSURE

This application claims the priority benefit of Provisional Patent Application Ser. No. 63/538,844, filed on Sep. 17, 2023, the full disclosure of which is incorporated herein by reference.

### TECHNICAL FIELD

The present invention relates to the food and beer industry, and in particular, to the extraction and formulation of high quality hops extracts. The primary focus of this application is to provide a new path of obtaining heavy resins free extracts and covers extraction and separation methods for isolation of acidic compounds contained in hop flowers and their antitumor, antimicrobial, and antioxidative effects.

### RELATED ART

Hop plants comprise a variety of natural compounds greatly differing in their structure and properties. A wide range of methods have been developed for their isolation and chemical analysis, as well as for determining their antioxidative, antimicrobial, and antigenotoxic potentials. Although hops remain the principal ingredient for providing the taste, stability, and antimicrobial protection of beer, they have found applications in the pharmaceutical and other food industries as well.

The hops has numerous health-promoting effects ranging from antioxidative, sedative, and anti-inflammatory potentials, over anticarcinogenic features to estrogenic activity. Therefore, hops should be exploited for the prevention and even healing of several prevalent diseases like cardiovascular disorders and various cancer types. New ideas for future studies on hops are finally presented: computational investigations of chemical reactivities of hop compounds, nanoencapsulation, and synergistic effects leading to a higher bioavailability of biologically active substances as well as the application of waste hop biomass from breweries for the production of high-added-value products in accordance with the biorefinery concept.

Over the last decades, the scientific world has turned its focus on exploring the biological effects of plants used in folk/traditional medicine. Such interest seems justified as almost all described effects of healing plants were also demonstrated through several in vitro and even in vivo studies. Therefore, it is reasonable to continue exploring in this field as gained knowledge represents the basis for development of new food supplements for disease prevention or even for the design of novel drugs, especially for the most prevalent threatening diseases of our time such as cardiovascular disorders, diabetes, Alzheimer's, and even cancer.

Increased demand for material goods is related to an increased occurrence of certain diseases that can be mostly ascribed to inappropriate dietary habits and to a stressful rapid way of life.

The food industry is in its prime time; however, along with obvious advantages this also brings numerous harmful consequences. Plain, organically grown food is becoming a privilege of the wealthy. Whereas, the diet of the poor and the middle class increasingly consists of almost exclusively anti-nutritional aliments filled with synthetic sugars, sensory properties enhancers, growth hormones, and preservatives. Listed substances are undoubtedly connected with the occurrence of several most prevalent diseases such as cardiovascular or neurological disorders and cancer.

Hop plant (Humulus lupulus L.), has been in continuous use for centuries or even a millennium mostly as an ingredient of beer, although some of its medicinal properties have been known as well. Nowadays its sedative effect is the most well-known, certain food supplements on its basis already exist for treating sleep disorders. Several in vitro and in vivo studies also show that certain hop compounds carry a potential for becoming novel anticancer agents as they exert significant, numerous, and diverse beneficial biological activities. Is it therefore of utmost importance to pursue the investigation of in vivo potential of hop and hop constituents as novel drugs or anticancer agents.

The use of various gasses in the sub- or supercritical state as extracting solvents has been under investigation for nearly half a century. A large number of natural products have been extracted with carbon dioxide and its commercial applications in the food industry are already well established. The earliest examples of such processes are decaffeination of coffee and production of hop extracts. Development of such processes and their scaling up are still highly topical. Several modifications of these processes have been reported with respect to the extraction procedure, the choice of an appropriate solvent and cosolvent for the isolation of the desired compound and the tunability of operating conditions.

New perspectives have also opened by the introduction of unconventional supercritical solvents, such as noble gasses and their mixtures, SF6, and of course water as the cheapest solvent. However, supercritical CO2 still remains the solvent of choice for these operations and indeed more than 90% of supercritical fluid extractions have been performed with CO2 as the supercritical solvent, mainly because of its easy penetration inside plant materials and high solvent power. Disadvantageously, its use is largely limited to the processing of dry raw materials and compounds of low polarity as well as low molecular weight.

Distillation has been traditionally used for obtaining essential oils from hops. Different approaches have been followed. The essential oil was obtained by passing steam through ground hops and removing the oil from the condensate by extraction with ether. The process took approximately 4 h for distillation of a 100 g sample of coarsely ground hops in 3 L of water. The effect of reducing the time taken for the usual steam distillation has been studied. In 1969, U.S. Pat. No. 3,436,319 A was issued, by Freiherr Von Horst and Kellner, for their “Thin Layer Steam Distillation of Hop Oil Extract”. The process is described as continuous and was proposed for obtaining the essential oil of hop preparations. The main feature of this process was the advantage of completely recovering the oil of hop from the steam distillate and simultaneously producing a residual hop extract containing other components of said extract in substantially unaltered form.

Traditional isolation methods are more and more frequently replaced by the advanced techniques combining sample preparation, separation, detection, and identification. Application of liquid carbon dioxide (LCO2) in the range of temperatures from 20 up to 25° C. and in the pressure range from 50 to 60 bar, respectively, was for example reported in 1966 for the extraction of hops. Stability of the obtained extract was however insufficient and has undergone a chemical change during storage.

An alternative approach was reported in 1977 by Laws and coworkers. Extraction of hops with supercritical CO2 was performed at temperatures between 4° and 50° C. and pressures between 150 and 400 bar. A high-quality hop extract was also obtained by using LCO2 at relatively low temperatures. A patent of Muller described the extraction at a temperature below the critical temperature (approximately 31° C.) but at a pressure higher than the critical one (73.25 bar). Next variation included the addition of a small amount of ethanol as a solvent to the liquid carbon dioxide.

The choice of an appropriate solvent represents the key factor for isolation of the compound of interest and depends on a number of factors, including dissolving power, selectivity, inflammability, volatility, and cost. Selectivity of LCO2 is for example used to provide hop extracts free of hard resins and polyphenolic materials. CO2 is thus a substitute for organic solvents of a highly nonpolar character, such as hexane and pentane. The range of organic species which dissolve in LCO2 includes hop resins and aroma components, paraffins, naphthenes, olefins, alcohols, aldehydes, phenols, esters, carboxylic acids, amines and nitrogen heterocycles, aromates, ketones, ethers, amides, and nitrites, but not polyphenols.

Ethanol as a polar solvent dissolves a broader range of hop components and represents a suitable solvent for extraction of polyphenols, compounds with structural phenolic features, which can be associated with different organic acids and carbohydrates. Typically 90% ethanol is used and the resulting extract possesses a very similar composition to the original hops. However, the total content of polyphenols is still lower with respect to the other groups of substances. Besides ethanol, scientific literature reports alternative organic solvents—such as methanol, acetone, and ethyl acetate—as effective extractive media for polyphenols as well as, to a lesser extent, propanol, dimethylformamide, and their combinations.

Considering industrial applications, the use of organic solvents is limited due to the fact that nontoxic solvents and the maximum residue levels of several solvents in the extracted foodstuff are strictly specified. Consequently, for the manufacture of hop extracts by breweries, carbon dioxide still remains the most applied solvent. High pressure or supercritical fluid extraction is especially suitable for isolation/fractionation of valuable ingredients from natural raw materials with limited solubility in CO2 at moderate pressures. The extracts contain nearly all essential oils in hops, as well as a sufficiently high ratio of α-acids (humulones) and less bitter lupulones, besides other components such as hard resins and traces of triglycerides, waxes, chlorophylls, and inorganic salts. The main feature distinguishing CO2 extracts from those prepared with conventional extraction is the lack of traces of undesired organic solvents. Therefore, supercritical CO2 extraction has become the industrial process of choice for the production of brewery ingredients.

Despite the abundant literature on extraction solvents and techniques for polyphenols from a different plant and herbal sources, there is surprisingly little information available on the effect of extraction conditions on the polyphenol content and antioxidative activities of hops and its products. Namely, the solubility of a solute depends on the solvent density that may vary considerably with changing extraction conditions, especially when operating in the sub- or supercritical region. With a higher temperature, moving towards the critical point, the solvent power increases. Optimum conditions for the extraction of a particular solute has to be therefore established experimentally by determining phase equilibria of this substance in a given solvent. Numerous studies have shown that organic solvents without the addition of water represent poor solvents for the extraction of polyphenols. Methanol or ethanol can also be mixed with water in different ratios. Alcohol concentration thus plays a key role in polyphenol recovery.

Despite several disadvantages, liquid-liquid and solid-liquid extractions are still the most commonly used isolation procedures. For several years, conventional techniques have been widely accepted, mainly because of their ease of use, efficiency, and wide-ranging applicability.

Typically, sterilized contaminant free components should be obtained from food and natural tissues in their chemically natural state. Harmful components from nutraceutical products should be removed; heavy metal recovery and enantiomeric resolution are also possible. Currently, solid phase microextraction is successfully applied for the characterization of aromatic properties of hops and other plant raw materials. On the contrary, for the isolation of nonvolatile compounds, solid-phase extraction, and solvent extraction are successfully used. For sample preparation, including purification and/or isolation of polyphenolic compounds, solid-phase extraction in offline columns has also become a popular and effective method. Moreover, accelerated solvent extraction has been recently applied for the extraction of bitter acids from hops and hop products. Finally, low-temperature levels, high yields, and a short process time represent the main advantages of ultrasound-assisted extraction. The procedure usually requires additional cooling, the main part of the applied energy is thereby transferred into heat to protect heat-sensitive substances. Due to cavitation, the cells of the plant material are highly disrupted.

Supercritical fluid extraction, routinely used for the production of bitter acid extracts for the beer brewing industry, represents an effective method for the isolation of both volatile and nonvolatile compounds of hops including essential oils. Operating conditions, temperature, and pressure used for the extraction markedly affect the composition of the obtained extract. Relatively high recovery of volatile compounds is obtained at lower temperatures, whilst elevated pressures and temperatures favor high recovery of bitter acids and resinous compounds. Unfortunately, under the conditions used in the extraction with supercritical carbon dioxide for the preparation of hop extracts for the brewing industry, a large group of biologically active prenylflavonoids (prenylchalcones and prenylflavanones) remains in the plant material.

Besides CO2, water is also relatively often used as an extraction medium, mainly due to the ability to become an excellent solvent for organic compounds and a very poor solvent for inorganic salts above its critical point (374° C., 218 atm). This means that the same solvent can be used to extract the inorganic and the organic components, respectively. Products obtained in this way are solvent-free, without the presence of coproducts and the operational temperature is in the case of CO2 low. The application of supercritical fluids (SCF) for extraction of natural substances at even higher pressures (over 70 MPa) than in conventional SCF extractions gives rise to new products from known plant materials such as the isolation of less soluble substances.

A method for extraction and dissolution of hop acids, including α-acids, iso-α-acids, β-acids, and their derivatives in aqueous media, also comprising of the formation of quaternary ammonium salts of hop acids with quaternary ammonium compounds or mixtures thereof has been recently developed by Mertens and Pascal. Hop acids containing matter are mixed with one or more quaternary ammonium compounds. Quaternary ammonium salts of hop acids are thereby formed. Their specific advantage is a high solubility in (acidic) aqueous medium compared to the corresponding hop acids in the free acid form. This invention further relates to the use of quaternary ammonium salts of hop acids in the beer brewing process and represents an effective concept of improving the utilization of hop acids, including α-acids and bitter taste contributing iso-α-acids, in this process.

Hop extracts obtained by supercritical CO2 extraction, show significant antibacterial potential against investigated bacterial strains. Xanthohumol has been proven to possess the highest activity against all tested strains. According to the literature, α- and β-acids, humulones and lupulones, and the isomerized forms of humulones might be considered as antimicrobial agents in hop extracts as well. Possible mechanisms of antibacterial activity of bitter acids and their derivatives might include the induced leakage of the bacterial membrane due to their highly hydrophobic character, especially of lupulone. Among organic solvents used for Soxhlet extraction, methanol and ethanol have been proven as efficient solvents for isolation of compounds with high antimicrobial activity. On the other hand, when n-hexane is used as a solvent, the resulting extract is less effective than methanol and ethanol extracts against tested bacteria and fungi.

### SUMMARY

The primary focus of this application is to provide a new path of obtaining heavy resins free extracts and covers extraction and separation methods for isolation of acidic compounds contained in hop flowers and their antitumor, antimicrobial, and antioxidative effects.

In one embodiment, an apparatus for extraction of hops with a liquified gas, comprising: at least one extractor vessel with a heating jacket; at least one evaporator; a solvent recovery vessel with a heating jacket; at least one chiller; a thermal pump cooling the at least one chiller and heating the at least one evaporator; a receiving vessel with a cooling jacket; and a pump moving solvent in the solvent recovery vessel; wherein the at least one extractor vessel, the at least one evaporator, the solvent recovery vessel, the one or more chillers, the thermal pump, the receiving vessel, and the pump work continuously under the same pressure conditions.

In one embodiment, an additional pump is installed before the receiver.

In one embodiment, more than one extractors are installed and switched to maintain the continued process of extraction.

In one embodiment, the hops are extracted to obtain a terpene fraction and a mixture of alpha and beta acids.

In one embodiment, the hops are decarboxylated and extracted obtain terpene fraction and mixture of iso alpha and iso beta acids.

In one embodiment, the mixture of terpene fraction and a mixture of alpha and beta acids and the mixture of iso alpha and iso beta acids is collected together from the same batch of material.

In one embodiment, the mixture of iso alpha and iso beta acids is extracted in the SHW system and mixed with the original fraction.

In one embodiment, a mixture of active compounds is mixed with surfactants and emulsifiers to obtain a water soluble fraction.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The brief description of the figures with general numbering of the elements of the practical applications of the methods considered in the patent is presented by schematic illustrations of various aspects of the methods and apparatus, without limitation of the possible variants of these methods, without unnecessary details unrelated to the essence of the protected by the author claims.

FIG. 1 illustrates a chart soft resins and terpenes presented at the hops plant.

FIG. 2 illustrates a chart of hard resins and hydrocarbons presented at the hops plant.

FIG. 3 illustrates a chart of solvent to plant actives extracted by those solvents.

FIG. 4 illustrates a diagram of an extraction system used in hops extraction.

FIG. 5 illustrates a diagram of a continuous extraction system.

FIG. 6 illustrates a diagram for the full process extraction alpha and beta acids from hops.

### DETAILED DESCRIPTION OF THE EMBODIMENTS

The embodiments of the present disclosure will be described below in conjunction with the relevant drawings. In the figures, the same reference numbers refer to the same or similar components or method flows.

Main components of hop essential oils such as monoterpenes and sesquiterpenes comprising humulene, bisabolene, caryophyllene, farnesene, and element skeletons are common targets of an optimized extraction process.

α-, β-, and iso-α-acids are known for their high potential to oxidize. Other compounds such as polyphenols, lipids, waxes, and polysaccharides for the bitter acid oxide fractions are essential due to their effect on beer properties as well as their potential health benefits. A total content of matured hop bitter acids (MHBA) is primarily composed of α-acid-derived oxides.

A variety of phenolic compounds, such as hexosides, dihexosides, pentosides, and quinic conjugates, such as feruloyl quinic acid, caffeic acid-O-hexoside, coumaric acid-O-hexoside, sinapic acid-O-hexoside, catechin-O-dihexoside, kaempferol-O-hexoside, and apigenin-C-hexosidepentoside, in beer extracts are reported as well.

Isoxanthohumol can be metabolized in the human liver to form 8-prenylnaringenin. Prenylnaringenin is an isomerization product of desmethylxanthohumol and until now, known as the most potent phytoestrogen isolated. Specific cytochrome P450 enzymes are responsible for the O-demethylation reaction. The enzymes that convert isoxanthohumol and 8-prenylnaringenin to their most abundant metabolites were identified.

Polyphenols are extremely important for the physical stability of beer during storage. Oxidation and polymerization of endogenous polyphenols and their interaction with proteins represent the main reason for beer turbidity. Catechin and proanthocyanidins (dimers and trimers of catechin, epicatechin, and gallocatechin) have displayed haze-forming activity with peptides in model systems. Total phenolics and antioxidative activities of hop extracts are commonly determined by the total phenolics are determined by the reduction of phosphotungstic acid and phosphomolybdic acid.

Hops have a long history of use as a natural preservative in beer due to high concentrations of unique bitter acids that inhibit the growth of Gram positive bacteria already at surprisingly low concentrations. Staphylococcus aureus is one of the most common Gram positive bacteria causing food poisoning. Its source is not the food itself, but the humans who contaminate the food after it has been processed. Despite the well-known high antibacterial, antifungal, and antiviral activities of hops, there is a lack of information about antimicrobial potentials of individual hop compounds. However, lupulone, humulone, isohumulone, and humulinic acid have shown high antimicrobial activity against certain bacteria like Bacillus subtilis 168.

Among several phenolic compounds present in plant extracts, flavone, quercetin, and naringenin have been proved as highly effective in inhibiting the growth of microorganisms due to their interaction with nucleic acid or proteins. Nonetheless, plant extracts generally contain a variety of flavonoids. The broad range of diverse chemical structures may reflect in different biological activities of extracts. Indeed, diverse extraction procedures give extracts with characteristic phenolic profile and different proportions of single phenolic compounds and this certainly influences the antioxidative properties of the extracts.

Even though naturally occurring substances as an essential part of edible plants and their products should pose no health risk, we cannot presume that the same applies for isolated compounds in higher doses and for other formulations especially in the form of phytopharmaceutical drugs. Therefore, also in the case of a naturally occurring substance with proven health-promoting effects, testing for potential toxicity and use of limited concentrations is essential for safe use.

Hop plant was long recognized only for its sedative (for insomnia) and antimicrobial (beer-stabilizing) properties. More concise studies revealed that hop plant or constituting substances possess several other biological properties such as strong antioxidative action, estrogenic activity, anti-inflammatory action, and several anticarcinogenic features like apoptosis-inducing, antimetastatic, antiproliferative, anti-invasive, or antiangiogenic properties. The above-listed features of hop plants have been generally ascribed to the biologically active compounds belonging to the group of secondary (hop) plant metabolites. Their primary role is to protect the plant from the predators, parasites, extreme weather conditions, and other threats.

Among several phenolic compounds present in plant extracts, flavone, quercetin, and naringenin have been proved as highly effective in inhibiting the growth of microorganisms due to their interaction with nucleic acid or proteins. Nonetheless, plant extracts generally contain a variety of flavonoids. The broad range of diverse chemical structures may reflect in different biological activities of extracts. Indeed, diverse extraction procedures give extracts with characteristic phenolic profile and different proportions of single phenolic compounds and this certainly influences the antioxidative properties of the extracts.

Even though naturally occurring substances as an essential part of edible plants and their products should pose no health risk, we cannot presume that the same applies for isolated compounds in higher doses and for other formulations especially in the form of phytopharmaceutical drugs. Therefore, also in the case of a naturally occurring substance with proven health-promoting effects, testing for potential toxicity and use of limited concentrations is essential for safe use.

Hop plant was long recognized only for its sedative (for insomnia) and antimicrobial (beer-stabilizing) properties. More concise studies revealed that hop plant or constituting substances possess several other biological properties such as strong antioxidative action, estrogenic activity, anti-inflammatory action, and several anticarcinogenic features like apoptosis-inducing, antimetastatic, antiproliferative, anti-invasive, or antiangiogenic properties. The above-listed features of hop plants have been generally ascribed to the biologically active compounds belonging to the group of secondary (hop) plant metabolites. Their primary role is to protect the plant from the predators, parasites, extreme weather conditions, and other threats.

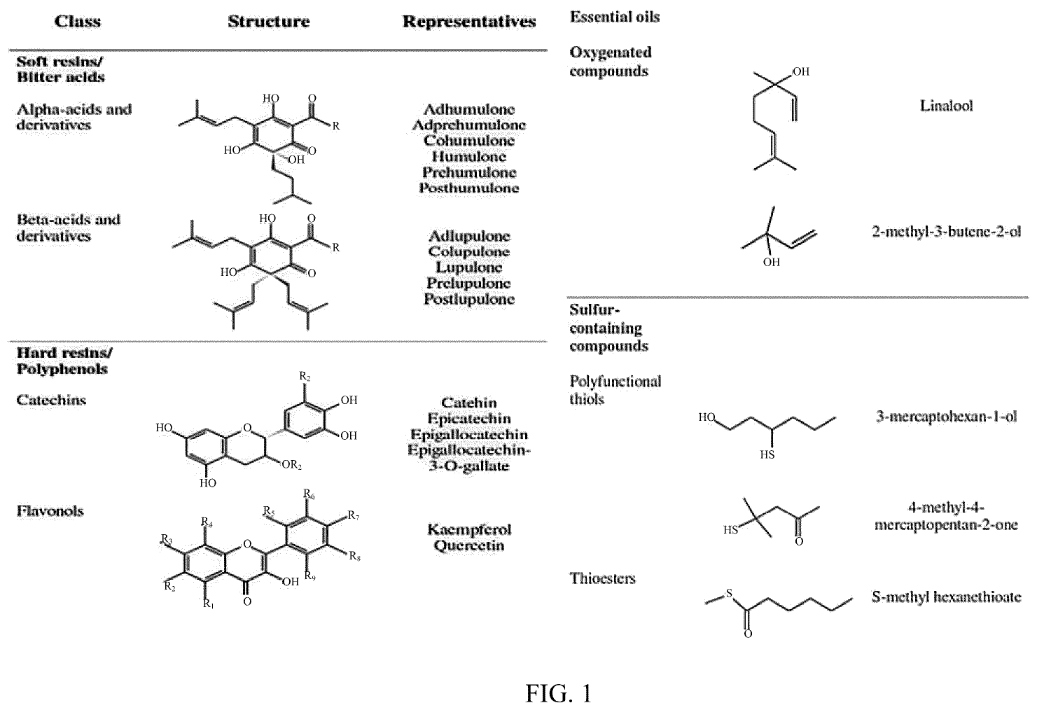

FIG. 1 illustrates a chart soft resins and terpenes presented at the hops plant.

The main groups of compounds found in hops, their (skeleton) chemical structures, and some typical representatives. Chemical structures of all typical representatives of soft and hard resins are collected.

Due to the high content of biologically active compounds, the biological effects of hops foremostly refer to the mature female hop cones (flowerings) and their extracts. Bitter acids and xanthohumol were also found in male inflorescences: their concentrations are similar to those found during early female flowerings. The presence of bitter acids and chalcones was also confirmed in the leaves of fully grown hops even if their levels were generally lower than in the hop cones and were strictly related to hop varieties. The hop leaves also contain volatile compounds, but in much lower amounts than the hop cones (<0.05%). Substances found in hops plants are commonly called resins.

According to their (in)solubility in hexane, the division to soft and hard resins is generally accepted; soft resins being hexane soluble. Soft resins found in yellow powder secreted by lupulin glands are mainly lupulic acids, chemically di- or tri-prenylated phloroglucinol derivatives, and homologs. Owing to their bitter taste, the term ‘bitter acids’ is adopted in the literature. Among soft hop bitter acids a division into two categories is adopted. α-acids (alpha lupulic acids or humulones) and their homologs represent the first category and the larger portion of soft resins, while the minor part represents the β-acids (beta lupulic acids) with homologs named lupulones.

The most important soft resin representatives of α-acids (FIG. 1) are humulone (35-70% of total α-acids), cohumulone (20-65% of total α-acids), and adhumulone (10-15% of total α-acids). As their chemical structures are very similar, the names and quantities of representative β-acids are analogous; lupulone (30-55% of total β-acids), colupulone, and adlupulone. Other minor representatives of bitter acids include posthumulone/postlupulone, prehumulone/prelupulone and adprehumulone. The quantities of both types of acids and their homologs, however, may vary greatly as they depend on the hop variety, climate and cultivation conditions.

The content of α-acids in different hop varieties also determines the content of xanthohumol, the main polyphenol in hops. When exposed to high temperatures (100-130° C.) and pH (8-10) as in the case of hop boiling during the brewing process, alpha-acids isomerize to iso-α-acids that next to oxidized hop acids-humulinones-predominantly to provide the bitter taste of beer. As a majority of hops is grown for the brewing industry, its price is proportional to the alpha-acid content.

Similar to the soft resins, the phenolic fraction of hop cones have been extensively studied. Xanthohumol, which represents more than 1% of dried hop cones, is especially interesting and remains a topic of research for several applications.

Prenylflavonoids represent a class of flavonoids with at least one prenyl or geranyl substituent in the ring. It was established that the prenyl substituent significantly alters the biological activity of corresponding flavonoids, likely due to the increased lipophilicity that improves the binding affinity towards biological membranes. Except for the case of estrogenicity of genistein, the shared observation is that prenylation elevates the biological effect of nonprenylated moieties, both phloroglucinol derivatives and flavonoids.

According to its content in hop cones, the class immediately following the prenylflavonoids is flavanols, also called catechins, as well as their polymers proanthocyanidins and condensed tannins. The most abundant in hop cones is flavanol (+)-catechin—the third most abundant of the individual compounds. This flavanol is predominantly found in hawthorn berries and leaves and became one of the active substances in herbal preparations for strengthening the cardiovascular function possessing both antioxidative and vasodilative features.

Flavonols are yet another class of flavonoids. The most prominent members of flavonols are quercetin and kaempferol. Both compounds can be found in various fruits and vegetables not only in hops. In the literature, quercetin and kaempferol are reported as one of the most potent antioxidants.

Hop cones also contain a certain amount of ferulic acid belonging to the hydroxycinnamic acids from the class of phenolic acids. For quite a while, ferulic acid was unjustifiably neglected as it possesses several health-promoting activities. It is similar to other highly antioxidative polyphenols as it prevents lipid peroxidation, apoptotic cell death of healthy cells, and is an effective and multifunctional free radical scavenger.

Essential oils, as is already evident from the name, represent the essence of the plant, meaning its distinctive aroma. Hop aroma has always intrigued mankind and it represents a significant portion of beer aroma. It is actually the quest for a better beer aroma that evidently brought so many hop varieties.

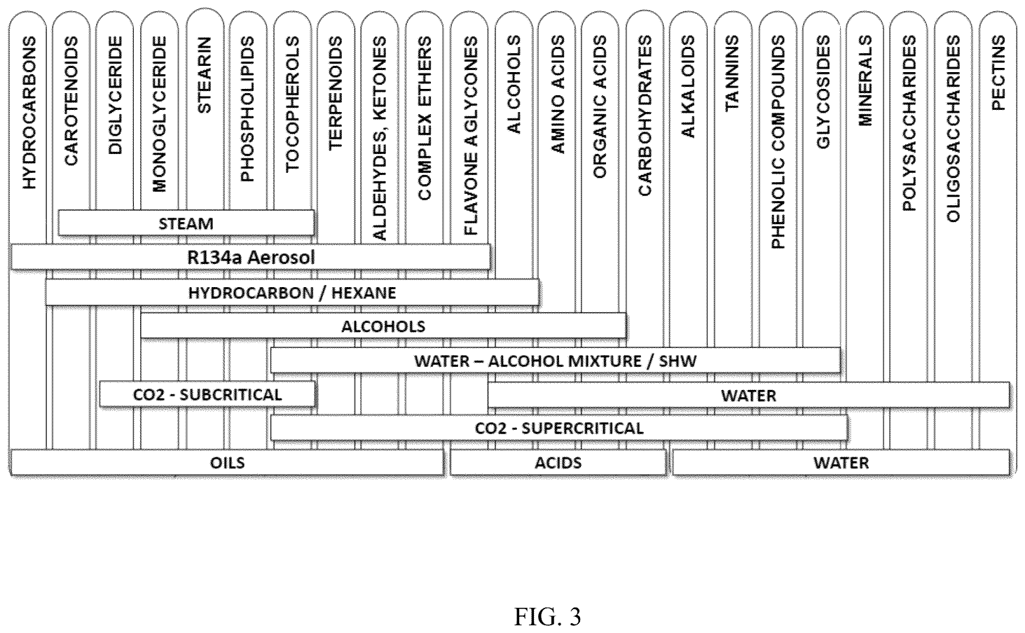

From above studies one skilled in the art will see how important is the selection of the correct solvent in order to have the correct mixture of constituents extracted with minimal expense and high yield. At FIG. 3 the general botanical chart is presented with the major solvents discussed above. The author of the invention investigated the solubility of a wide range of solvents and presented the various solvent performance at FIG. 3.

The solvent proposed for the extraction process is 1,1,1,2 tetrafluoroethane (HFC-134a). In essence, it is a non-polar solvent with dielectric permittivity at 20° C. and 100 kHz 1,013, dipole moment of the molecule 2,060 Debay and polarizability 13.8 cm3/mol. Hence there is a negligible solubility of the water around 1.1 g water/kg at 20° C. This also makes it perfect for extraction of fresh, even wet materials. Its dynamic viscosity and surface tension at 20° C. are small, respectively 198 mPa·s and 8 mN/m, which allows its easy penetration into plant cells and extraction of components from them. Its pressure at 20° C. is 0.57 MPa, which allows the extraction process to be carried out at acceptable pressures of 0.2 to 0.7 MPa.

Its specific heat of boiling is low, about 200 KJ/kg in the temperature regime used, which determines the small energy costs for the extraction process. It is chemically inert and well compatible with copper and carbon steel. HFC-134a is harmless to the human body and non flammable. Since 14.10.1996 the Scientific Council on Food of the European Commission with an addition to the “Solvents Directive” included HFC-134a as allowed for the extraction of flavorings used in foodstuffs.

Later, in 1998, it was accepted also by the American FDA. As a new developed chemical its impact on the greenhouse effect is minimal with a factor of HGWP=0.285. It is widely used in the medical field as aerosol drug delivery, industrial as high efficiency cleaning solution, aerospace as fire propellant and in military as additive and delivery system which justifies the wide industry implementation. It is completely recovered between two extraction cycles and this further minimizes its losses and increases its production efficiency.

Multiple trials were made with different types of raw materials in a laboratory installation to confirm the indicated extraction range at FIG. 3. This indicates that with subsequent extraction of the spent raw material with polar solvent as water-ethanol mixture or superheated water (SHW), it would cover the full range of extracted substances. This would also contribute to the destruction of the plant structure during extraction with liquefied gas. With this two-stage extraction, the yields in quantity and quality would be analogous to those obtained in supercritical extraction, which would replace the current expensive and inefficient methods while extracting a full range of target ingredients.

The obtained extracts with HFC-134a are in most cases clear, yellow-brown colored liquids with the characteristic aroma of the raw material (including those from thermolabile raw materials such as lilac, hyacinth and lily). By chemical composition, they are close to essential oils, and in some there is the presence of waxes. All the extracts obtained are soluble in ethyl alcohol and insoluble in water. A complete absence of solvent was observed in the extracts.

The results from the HFC-134a extraction are shown at Table 1. The table shows extraction of two common strains of hops. The first column shows the potency of the received biomass and the second shows the potency of the extract, the third shows the ratio of the concentration from plant to extract. The next three columns show the performance of another strain. As one can see the ratio between the actives in flower and extract are 70-100 times repeated in the extract.

TABLE 1

| | Simcoe | Simcoe | Extraction | N Sauvin | N Sauvin | Extraction |
|---|---|---|---|---|---|---|
| Description | Flower | Extract | Ratio | Flower | Extract | Ratio |
| Essential Oil | 1.57 mg/g | 112.17 mg/g | 71.45 | 1.55 mg/g | 154.36 mg/g | 99.59 |
| Alpha Acids | 0.73 mg/g | 51.13 mg/g | 70.04 | 0.63 mg/g | 37.79 mg/g | 59.98 |
| Beta Acids | 0.31 mg/g | 24.47 mg/g | 78.94 | 0.49 mg/g | 37.17 mg/g | 75.86 |

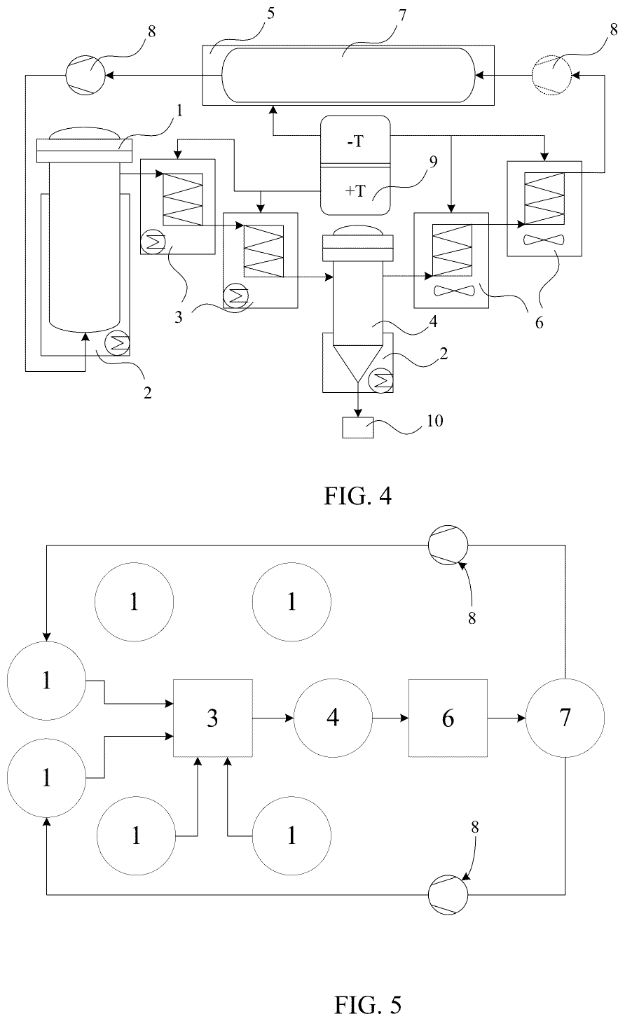

The liquified gas system used for extraction of hops is described at FIG. 4 and various implementations are referenced in the past by the author (U.S. Pat. No. 11,331,595B2, U.S. Pat. No. 11,248,189B2, U.S. Pat. No. 11,090,578B2, US20230124244A1). The extractor 1 has a heating component 2 to achieve the proper working temperature. The material is placed in the extractor 1 and solvent from receiver 7 which is preliminary chilled by the cooling jacket 5 is pumped with a liquid/gas pump 8 to the extractor. The material is continuously washed and the overfill with the extract and solvent is fed to the one or multiple stages of evaporation circuits 3 then enters the separation vessel 4 equipped with a heating jacket 2.

The evacuated gas solvent has been recovered in the separation vessel 4 and fed to liquify in one or multiple condensers 6 equipped with chilling from the thermal pump 9. The thermal pump is used to heat the evaporators 3 and chill the condensers 6 at the same time to increase the efficiency and lower the processing power. The chilled vapors are condensed back in the receiver 7 either by gravity or optional liquid/gas phase pump 8. The extract is drained from the separation vessel 4 free of solvent to a flask 10.

The system is uniquely designed to maintain the same pressure through the entire process of extraction, evaporation, separation and recovery which is a unique state of art not used in other liquified gas systems that are usually working on change of pressure in each stage. This architecture insures fast and continues extraction using liquified gas HFC-134a or similar C1 to C4 fluorinated hydrocarbons like example R134a, R143a, R23, R404a, R407, R410, R417, R422, R507, R1234ze, R227ea, R152a, R508 or similar, and more specifically R134a known as 1,1,1,2-tetrafluoroethane.

The process for extracting the alpha and beta acids of hops is as described in the system above under room temperature conditions of 30° C. and pressure of 9-10 bars through the entire system. This process yields the results shown at table 1 with typical yields relative to the maintained active substances in the biomass. The typical yield has been 15% for the alpha and beta acid fraction.

Further processing the iso acids can be done with one of the two steps described below. The first routine is to decarboxylate the extracted biomass at 135° F. for one hour and run again through the same system. This yielded iso acids extract was around 2%. The flowchart of the process is shown at FIG. 5. The complete extract from the same batch of material is mixed and collected together from the collection vessel 10.

How to make the continuous extraction is by duplicating the extraction vessel as many times as necessary to keep the loading of material consistent to feed the continued evaporation and switching it to the evaporation path while recovering the solvent and replacing the extracted material. Usually the extractors are separate to the recovery skid and they can be easily multiplied and switched. At FIG. 5 such a continuous system is shown with six extractor 1 vessels and preserving the main evaporation path comprising vessels 3, 4, 6, 7.

The continuous extraction works as follows. The material is loaded in one of the extraction vessels 1 and continuously washed with solvent under pressure from the receiver vessel 7. The overspill of the solvent with the active compounds called miscella is continuously fed to the evaporators 3 under the same constant pressure and then evaporated in the evaporator 4 under the same pressure. The vapors are chilled and liquified by the condenser 6 and collected in the receiver 7 from where they are continuously reverted back to the current active extractor 1 via the pump 8. The extractors 1 are switched on time, for example every 30 minutes on a rotary principle.

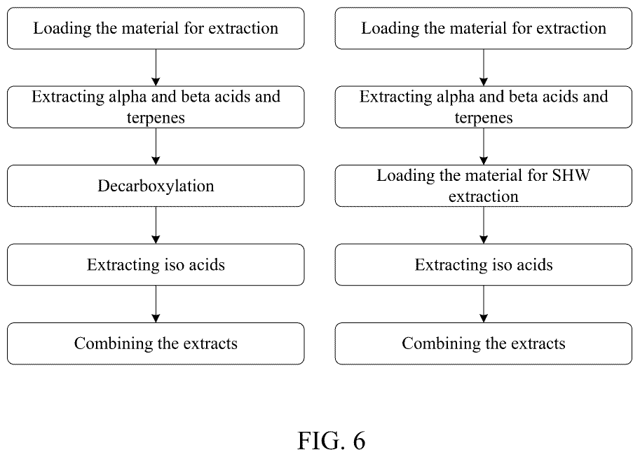

Another process for extraction of iso acids has been proposed with a superheated water (SHW) system as a secondary operation. The SHW system used is patented by the inventor US patent U.S. Ser. No. 15/857,893. The process is shown at FIG. 6.

With the optimized process for extraction of alpha and beta resins and other target compounds described above the inventor outlines a more efficient and faster process for obtaining the most valuable components from hops with much better clarity of terpenes and active compounds extracted at room temperature conditions, with natural potency.

Further the brewers are looking for creative ways to find efficiencies and/or differentiation. This has been driven by changing consumer preferences, interest in new flavors and flavor combinations, and an increased focus on health and well-being. Creating hop-derived aqueous extract that is clear, flowable, variety specific, and true-to-type is a desire of every brewery. An extract that provides enhanced hop flavors and aromas while reducing and/or complementing the use of dry-hop pellets and other flavor ingredients.

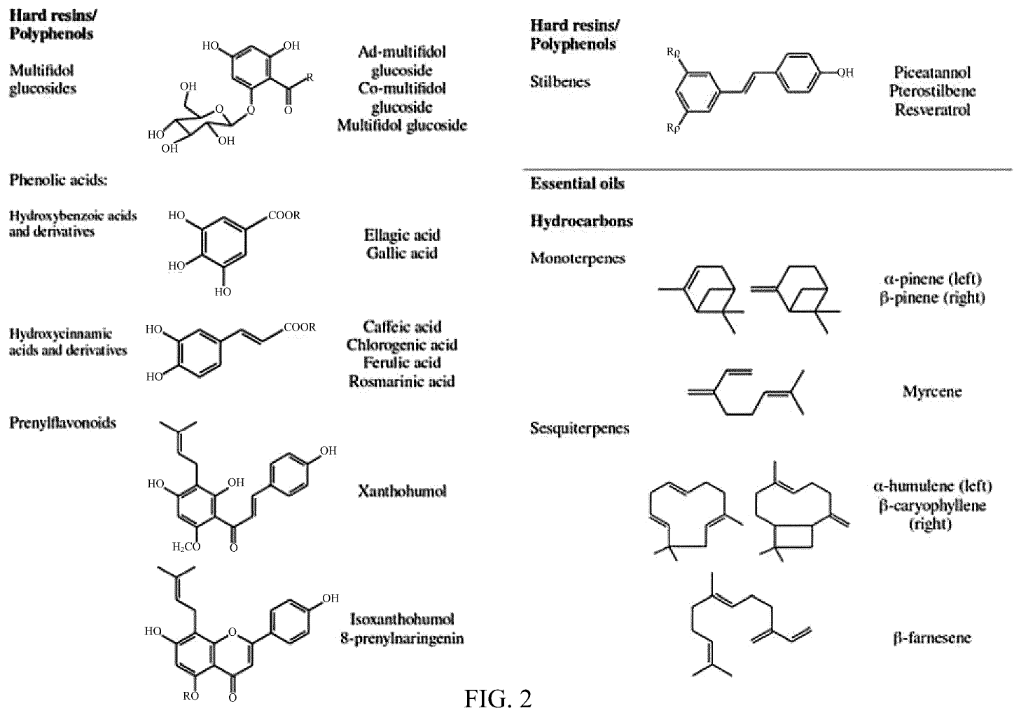

The extracts obtained according the process flow shown at FIG. 6 contain all active ingredients explained at FIG. 2: soft and hard resins, terpenes and sulfur containing compounds and those can be brought to a water soluble form by emulsification with surfactants and emulsifiers which additionally brings up the taste and flavor of the active compounds and helps proper dosing at any stage of the brewing either as main or supplemental flavoring.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. An apparatus for extraction of hops with a liquified gas, comprising:
at least one extractor vessel with a heating jacket;
at least one evaporator;
a solvent recovery vessel with a heating jacket;
at least one chiller;
a thermal pump cooling the at least one chiller and heating the at least one evaporator;
a receiving vessel with a cooling jacket; and
a pump moving solvent in the solvent recovery vessel;
wherein the at least one extractor vessel, the at least one evaporator, the solvent recovery vessel, the one or more chillers, the thermal pump, the receiving vessel, and the pump work continuously under the same pressure conditions.

2. The apparatus of claim 1, wherein an additional pump is installed before the receiver.

3. The apparatus of claim 1, wherein more than one extractors are installed and switched to maintain the continued process of extraction.

4. The apparatus of claim 1, wherein the hops are extracted to obtain a terpene fraction and a mixture of alpha and beta acids.

5. The apparatus of claim 1, wherein the hops are decarboxylated and extracted obtain terpene fraction and mixture of iso alpha and iso beta acids.

6. The apparatus of claim 5, wherein the mixture of terpene fraction and a mixture of alpha and beta acids and the mixture of iso alpha and iso beta acids is collected together from the same batch of material.

7. The apparatus of claim 5, wherein the material is also extracted in the SHW system.

8. The apparatus of claim 1, wherein a mixture of active compounds is mixed with surfactants and emulsifiers to obtain a water soluble fraction.
